(19) United States
(12) Patent Application Publication
(10) Pub. No.: US 2014/0158229 A1
(43) Pub. Date: Jun. 12, 2014

(54) VALVE DEVICE

(71) Applicant: DENSO CORPORATION, KARIYA-CITY (JP)

(72) Inventors: Ryoyu Kishi, Kariya-city (JP); Shinji Sugihara, Mizuho-city (JP)

(21) Appl. No.: 14/031,604

(22) Filed: Sep. 19, 2013

(30) Foreign Application Priority Data
Dec. 6, 2012 (JP) 2012-266890

(51) Int. Cl. F16K 17/04; F16K 15/02

(52) U.S. Cl. CPC F16K 17/04; F16K 15/025
USPC 137/535

(57) ABSTRACT

A first seal portion forms, when seated on a first seated position, a valve side chamber blocked from a relief chamber to have an equivalent fluid pressure to fluid pressure in a pressure-controlled chamber. The first seal portion causes, when lifted from the first seated position on increase in fluid pressure in the pressure-controlled chamber, the valve side chamber to disappear and to communicate the relief chamber with the pressure-controlled chamber. A second seal portion partitions, when seated on a second seated position, a part of the valve side chamber from the other part of the valve side chamber. The second seal portion is configured to be lifted from the second seated position on increase in fluid pressure in the pressure-controlled chamber, before the first seal portion is lifted from the first seated position.

### CROSS REFERENCE TO RELATED APPLICATION

This application is based on reference Japanese Patent Application No. 2012-266890 filed on Dec. 6, 2012, the disclosure of which is incorporated herein by reference.

### TECHNICAL FIELD

The present disclosure relates to a valve device configured to release fluid from a pressure-controlled chamber, such as a fuel tank of a vehicle, to reduce a fluid pressure (inner pressure) in the pressure-controlled chamber to control the inner pressure.

### BACKGROUND

Conventionally, a known valve device is configured to release fluid from a vapor-phase space in a fuel tank of a vehicle to reduce an inner pressure of the fuel tank to control the inner pressure.

The known valve device includes, for example, a valve element and a spring. The valve element is configured to open to communicate the vapor-phase space of the fuel tank with the atmospheric space. The valve element is further configured to close the vapor-phase space of the fuel tank from the atmospheric space. The spring biases the valve element toward a close side. The valve device applies the inner pressure to the valve element toward an open side. When the inner pressure increases, the valve element in a seated position is lifted to release fluid from the vapor-phase space. That is, the valve device has a check valve configuration to apply a high fluid pressure to the valve element toward the open side and to cause the high fluid pressure to lift the valve element, which is in the seated position, against the biasing force of the biasing unit.

The valve device is configured to release fluid from the vapor-phase space by a specified flow quantity, such as several liters/min, when the inner pressure is at a desired relief pressure. A release flow quantity of fluid from the vapor-phase space becomes the specified flow quantity in a specified state. In order to reduce the inner pressure by a specific quantity, it is increasingly demanded in such a valve device to reduce an allowance of a valve opening pressure, as described subsequently.

Herein, the valve opening pressure allowance is defined, for example, as a difference between a valve opening pressure and a relief pressure. The valve opening pressure is a critical inner pressure immediately before the valve element in the seated position is lifted. The valve opening pressure is, for example, a pressure in which a flow quantity of fluid leaking from the vapor-phase space is a minute quantity, such as several cubic centimeters/min. The relief flow quantity becomes a predetermined minute quantity in a critical state.

The valve opening pressure allowance is set mainly by determining a characteristic of the spring, such as a free length of the spring, a spring constant of the spring, and/or the like, according to an operating condition of the valve device. That is, the valve opening pressure allowance is set by selecting the biasing unit or by adjusting the biasing unit according to the operating condition of the valve device. Therefore, it is significantly difficult to reduce the valve opening pressure allowance beyond a certain limit.

Patent Documents 1 and 2 disclose prior arts related to valve devices each having a check valve configuration, as follows. For example, Patent Document 1 discloses a configuration including an annular projected portion (73c) equipped in an outer circumferential periphery of a valve element (71). In Patent Document 1, the valve element (61, 71) is displaced toward the open side quickly to enlarge a crosssectional area of a relief passage, thereby to produce a specific flow characteristic.

Patent Document 2 discloses a configuration including a seal portion (12), which directly blocks an outflow hole of high-pressure fluid, and a valve element (3A), which includes a seal portion (13) seated on a radially outside of the outflow hole. In Patent Document 2, the seal portion (12) is formed of a soft material, and the seal portion (13) is formed of a material harder than the seal portion (12), thereby to produce a specific sealing property regardless of a difference between a fluid pressure on a high-pressure side and a fluid pressure on a low-pressure side. Nevertheless, it is noted that, both Patent Documents 1 and 2 do not have an object to reduce the valve opening pressure allowance. In both Patent Documents 1 and 2, it is conceivable that there is no option to reduce the valve opening pressure allowance other than selection and/or adjustment of the biasing unit.

(Patent Document 1)

Publication of Unexamined Japanese Patent Application No. 2005-081862

(Patent Document 2)

Publication of Unexamined Japanese Patent Application No. 2006-292152

### SUMMARY

It is an object of the present disclosure to produce a valve device including a check valve configuration and configured to reduce a valve opening pressure allowance.

According to an aspect of the present disclosure, a valve device is configured to release fluid from a pressure-controlled chamber, which is a pressure-controlled object, to decrease and control a fluid pressure in the pressure-controlled chamber. The valve device comprises a valve element. The valve element is configured to block a relief chamber, which is configured to receive fluid from the pressure-controlled chamber, from the pressure-controlled chamber. The valve element is further configured to be biased and displaced, on application of a fluid pressure in the pressure-controlled chamber, to communicate the relief chamber with the pressure-controlled chamber. The valve device further comprises a biasing unit configured to bias the valve element in a direction to block the relief chamber from the pressure-controlled chamber. The valve device further comprises a first seal portion being a part of the valve element. The first seal portion is configured to be seated on a predetermined first seated position to form a valve side chamber, which is blocked from the relief chamber to have a fluid pressure equivalent to a fluid pressure in the pressure-controlled chamber. The first seal portion is further configured to be lifted from the first seated position, on increase in a fluid pressure in the pressure-controlled chamber, to cause the valve side chamber to disappear and to communicate the relief chamber with the pressure-controlled chamber. The valve device further comprises a second seal portion being a part of the valve element. The second seal portion is configured to be seated on a predetermined second seated position in the valve side chamber, when the valve side chamber is formed, to partition a part of the valve side chamber from an other part of the valve side chamber. The second seal portion is further configured to be lifted from the second seated position, on increase in a fluid pressure in the pressure-controlled chamber, before the first seal portion is lifted from the first seated position.

### BRIEF DESCRIPTION OF THE DRAWINGS

The above and other objects, features and advantages of the present invention will become more apparent from the following detailed description made with reference to the accompanying drawings. In the drawings:

FIG. 1A is a view showing a valve device, in which both a first seal portion and a second seal portion are seated, according to an embodiment, FIG. 1B is a view showing the valve device, in which only the first seal portion is seated, and FIG. 1C is a view showing the valve device, in which both the first seal portion and the second seal portion are lifted;

FIG. 2 is a graph showing a correlation between an inner pressure and a relief flow quantity, according to the embodiment; and

FIG. 3A is a view showing a valve device according to a modification of the embodiment, in which both a first seal portion and a second seal portion are seated, and FIG. 3B is a view showing the valve device, in which only the first seal portion is seated.

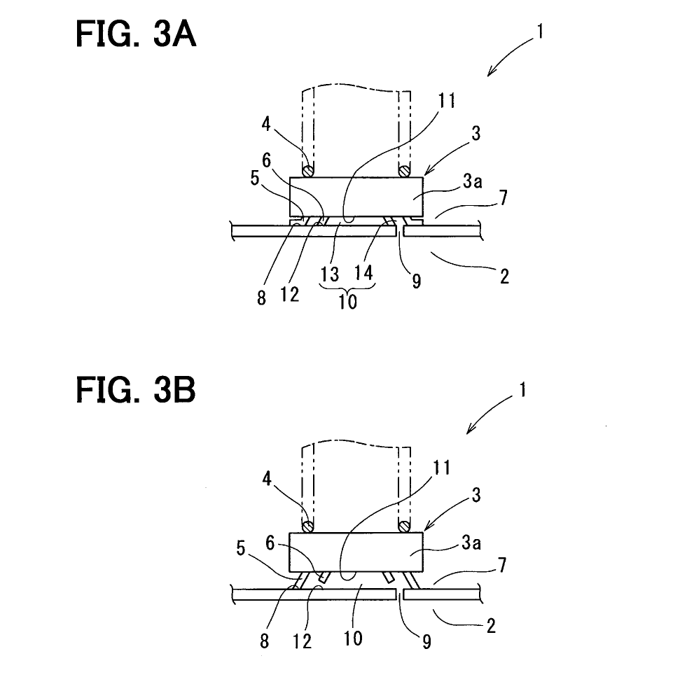

### DETAILED DESCRIPTION

As follows, a valve device 1 according to an embodiment of the present disclosure will be described.

### Embodiment

### Configuration of Embodiment

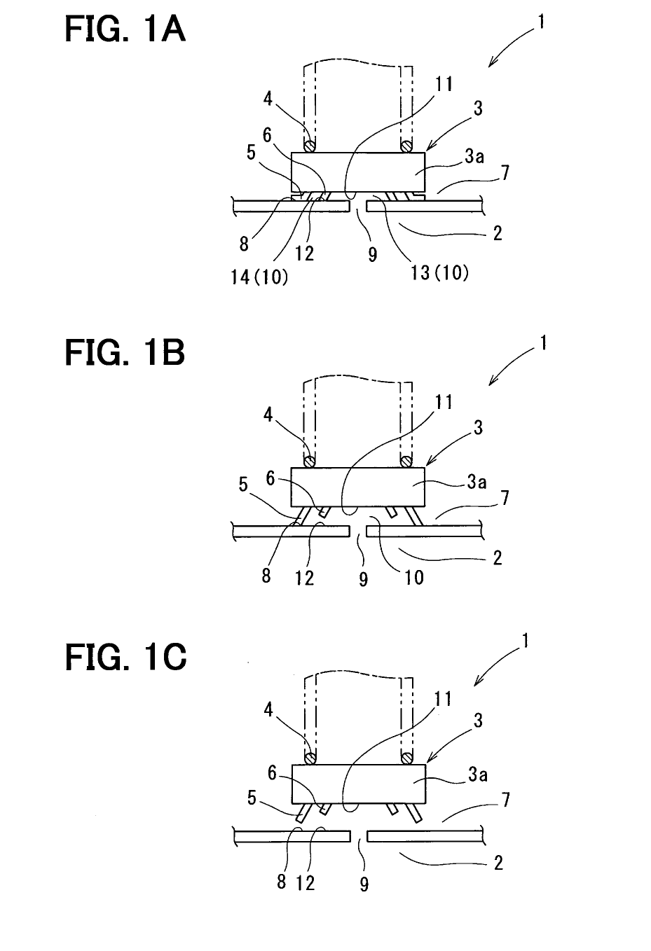

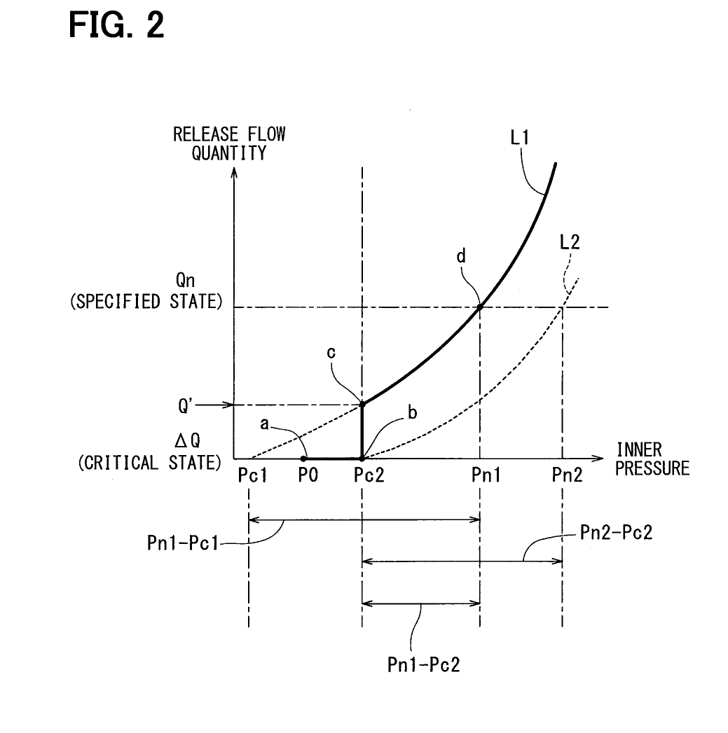

A configuration of the valve device 1 of the embodiment will be described with reference to FIGS. 1 and 2. As shown in FIG. 1, the valve device 1 is configured to release fluid from a pressure-controlled chamber 2 thereby to reduce a fluid pressure (inner pressure) in the pressure-controlled chamber 2 to control the inner pressure. In the present configuration, the pressure-controlled chamber 2 is a pressure-controlled object. The valve device 1 may be employed to control, for example, the inner pressure of a fuel tank, which is equipped to a vehicle. The valve device 1 includes a valve element 3, a biasing unit 4, a first seal unit 5, and a second seal unit 6, as described below.

The valve element 3 is configured to partition and block a relief chamber 7 from the pressure-controlled chamber 2. The valve element 3 is further configured to be displaced, on application of the inner pressure, to communicate the relief chamber 7 with the pressure-controlled chamber 2 to flow fluid from the pressure-controlled chamber 2 into the relief chamber 7. The biasing unit 4 is configured to bias the valve element 3 in a direction to close a space between the relief chamber 7 and the pressure-controlled chamber 2. The biasing unit 4 is, for example, a coil spring. In the above-described configuration, the valve device 1 functions as a check valve to apply the inner pressure onto the valve element 3 toward an open side, thereby to cause the inner pressure to lift the valve element 3, which is in a seated position, against a biasing force of the biasing unit 4. Thus, the valve device 1 releases fluid from the pressure-controlled chamber 2 into the relief chamber 7.

The first seal unit 5 is a part of the valve element 3 and is configured to be seated in a predetermined first seated position 8. For example, the first seated position 8 is set, such that the first seal unit 5 is positioned on the side of the relief chamber 7 to surround the outflow hole 9, which is a fluid passage from the pressure-controlled chamber 2 into the relief chamber 7. The first seal unit 5 is seated in the first seated position 8, thereby to surround the outflow hole 9 on the side of the relief chamber 7 to form a valve side space 10.

The valve side space 10 is blocked from the relief chamber 7 and is communicated with the pressure-controlled chamber 2 through the outflow hole 9. The valve side space 10 is in a fluid pressure, which is equivalent to the inner pressure of the pressure-controlled chamber 2, when fluid flows from the pressure-controlled chamber 2. That is, the valve side space 10 exists as a part of the pressure-controlled chamber 2, when the pressure-controlled chamber 2 is blocked from the relief chamber 7. When the inner pressure increases to lift the first seal unit 5 from the first seated position 8, the valve side space 10 disappears, and the relief chamber 7 is communicated with the pressure-controlled chamber 2. The first seal unit 5 is, for example, in an annular shape and is projected from a sealing surface 11 of a main body 3a of the valve element 3. The sealing surface 11 is opposed to the outflow hole 9.

The second seal unit 6 is a part of the valve element 3. The second seal unit 6 is seated in a predetermined second seated position 12, which is in the valve side space 10, when the valve side space 10 is formed. For example, the second seated position 12 is set, such that the second seated position 12 surrounds the outflow hole 9 on the radially inner side of the first seated position 8. The second seal unit 6 partitions a part of the valve side space 10 from the other part of the valve side space 10, when the second seal unit 6 is seated on the second seated position 12.

When the inner pressure increases, the second seal unit 6 is lifted from the second seated position 12, before the first seal unit 5 is lifted from the first seated position 8. That is, when the inner pressure increases, the second seal portion 6 is lifted prior to lift of the first seal portion 5. In consideration of the configuration to lift the second seal portion 6 prior to lift of the first seal portion 5, the second seal portion 6 is configured to have a sealing property less than a sealing property of the first seal portion 5.

The difference between the sealing properties can be produced by, for example, differentiating a surface pressure, which is applied from the first seal portion 5 onto the first seated position 8, from a surface pressure, which is applied from the second seal portion 6 onto the second seated position 12. More specifically, for example, the difference between the sealing properties can be produced by setting a projection height of the second seal portion 6 from the sealing surface 11 to be lower than a projection height of the first seal portion 5 from the sealing surface 11. Alternatively, for example, the difference between the sealing properties can be produced by setting a shape of the second seal portion 6 to be thicker and/or less-bendable than the first seal portion 5.

The second seal portion 6 is, for example, in an annular shape and is projected from the sealing surface 11 on a radially inner side of the first seal portion 5. In the present configuration, as shown in FIG. 1A, while the second seal portion 6 is seated on the second seated position 12, the valve side chamber 10 is partitioned into a region 13 and a region 14. The region 13 is located on the radially inner side and is surrounded by the second seal portion 6. The region 14 is located on the radially outer side and is interposed between the first seal portion 5 and the second seal portion 6 to be in an annular shape.

The outflow hole 9 opens to the region 13 on the radially inner side. When fluid flows from the pressure-controlled chamber 2 into the region 13 on the radially inner side, the region 13 on the radially inner side is in a fluid pressure (inner pressure), which is equivalent to the inner pressure of the pressure-controlled chamber 2. That is, when the second seal portion 6 is seated on the second seated position 12, the region 13 on the radially inner side forms a part of the pressure-controlled chamber 2. In addition, when the second seal portion 6 is seated on the second seated position 12, fluid is unable to flow from the pressure-controlled chamber 2 into the region 14 on the radially outer side. Therefore, in this state, fluid pressure in the region 14 on the radially outer side is lower than fluid pressure in the pressure-controlled chamber 2. Thus, the region 14 on the radially outer side does not from a part of the pressure-controlled chamber 2.

In the present configuration, when the second seal portion 6 is seated on the second seated position 12, a pressure-applied surface, via which the valve element 3 receives the inner pressure, is limited to an area of the sealing surface 11 on the radially inner side of a root of the second seal portion 6. When the second seal portion 6 is lifted from the second seated position 12, the pressure-applied surface is enlarged to an area of the sealing surface 11 on the radially inner side of a root of the first seal portion 5.

### Operation of Embodiment

An operation of the valve device 1 of the embodiment will be described with reference to FIGS. 1A to 2. In the following description, when a pressure-applied area of the pressure-applied surface, via which the valve element 3 receives the inner pressure, is enlarged to the radially inner side of the root of the first seal portion 5, the enlarged pressure-applied area is represented by A1. Alternatively, when the pressure-applied area of the pressure-applied surface is limited within the radially inner side of the root of the second seal portion 6, the limited pressure-applied area is represented by A2. Furthermore, as shown in FIG. 2, a correlation between a relief flow quantity in the valve device 1 and the inner pressure in the valve device 1 is represented by a correlation line L1, in a configuration, in which the second seal portion 6 is not equipped, and the pressure-applied area is maintained constantly at the area A1. Alternatively, a correlation between the relief flow quantity in the valve device 1 and the inner pressure in the valve device 1 is represented by a correlation line L2, in a configuration, in which the first seal portion 5 is not equipped, and the pressure-applied area is maintained constantly at the area A2.

In the configuration, in which the valve element 3 includes only the first seal portion 5 and the correlation between the relief flow quantity and the inner pressure is along with the correlation line L1, a fluid pressure in a critical state, in which the relief flow quantity is a predetermined minute quantity ΔQ, is represented by a pressure Pc1. In the same configuration, a fluid pressure in a critical state, in which the relief flow quantity is a predetermined specified quantity Qn, is represented by a pressure Pn1.

In the configuration, in which the valve element 3 includes only the second seal portion 6 and the correlation between the relief flow quantity and the inner pressure is along with the correlation line L2, a fluid pressure in a critical state, in which the relief flow quantity is the minute quantity ΔQ, is represented by a pressure Pc2. In the same configuration, a fluid pressure in a critical state, in which the relief flow quantity is the specified quantity Qn, is represented by a pressure Pn2.

The quantity Qn is 1000 times or more the quantity ΔQ, and therefore, the quantity ΔQ is deemed to be substantially zero, in consideration from the digits of the quantity Qn. Therefore, at the positions, in which the correlation lines L1 and L2 rise from the horizontal axis respectively, the pressure Pc1 and the pressure Pc2, substantially coincide with the vertical coordinate of the horizontal axis. It is noted that, the area A1 is greater than the area A2. Therefore, a force (open-side biasing force) caused by the inner pressure to bias the valve element 3 toward the open side when the correlation between the relief flow quantity and the inner pressure is along with the correlation line L1 is greater than the open-side biasing force when the correlation is along with the correlation line L2. Therefore, a pressure required to lift the valve element 3, in the configuration in which the correlation is along with the correlation line L1, is lower than a pressure required to lift the valve element 3 in the configuration in which the correlation is along with the correlation line L2. Furthermore, in the configuration in which the correlation is along with the correlation line L1, the relief flow quantity reaches the specified quantity Qn at the pressure Pn1. In the configuration in which the correlation is along with the correlation line L2, the relief flow quantity reaches the specified quantity Qn at the pressure Pn2. The pressure Pn1 is lower than the pressure Pn2. Therefore, the following relation exists: Pc1<Pc2, Pn1<Pn2.

On the above-described premise, a state is assumed that, in the valve device 1, in which the valve element 3 includes both of the first seal portion 5 and the second seal portion 6, the inner pressure increase from a pressure P0, which is sufficiently lower than the pressure Pc2. In the presently assumed state, as shown in FIG. 2 by a thick line in a range between the point a and the point b, when the inner pressure is lower than the pressure Pc2, the second seal portion 6 is seated on the second seated position 12 in the valve side chamber 10. Therefore, the second seal portion 6 prohibits fluid from flowing into the region 14 on the radially outer side from the pressure-controlled chamber 2. Thus, a fluid pressure increases only in the region 13 on the radially inner side, as the inner pressure increases. In the present state, the first seal portion 5 is also seated on the first seated position 8, and therefore, the relief flow quantity does not increase from zero. In addition, the pressure-applied area of the valve element 3 is constantly at the area A2.

Thereafter, when the inner pressure increases to be close to the pressure Pc2, the second seal portion 6 in the valve side chamber 10 is in a state immediately before being lifted from the second seated position 12. That is, the critical state exists between the second seal portion 6 and the second seated position 12. Thus, fluid starts to flow at the minute quantity ΔQ from the region 13 on the radially inner side into the region 14 on the radially outer side. Subsequently, as shown in FIG. 1B, the second seal portion 6 is lifted completely from the second seated position 12 to increase an inflow quantity of fluid from the region 13 on the radially inner side into the region 14 on the radially outer side. Thus, a fluid pressure in the region 14 on the radially outer side begins to increase.

As a result, the pressure-applied area, via which the inner pressure is applied onto the valve element 3, abruptly increases from the area A2 to the area A1 to increase the valve-open biasing force, abruptly. Therefore, the space between the first seal portions 5 and the first seated position 8 moves into a critical state, immediately. Subsequently, as shown in FIG. 1C, the first seal portion 5 is lifted completely from the first seated position 8, and the valve side chamber 10 disappears. Thus, the space between the relief chamber 7 and the pressure-controlled chamber 2 is released completely. In the above-described configuration, as shown in FIG. 2 by the thick line in the range between the point b and the point c, after the second seal portion 6 is lifted, the valve element 3 is quickly lifted without significant increase in the inner pressure from the pressure Pc2. Therefore, the relief flow quantity quickly exceeds the minute quantity ΔQ. The relief flow quantity further increases to a quantity Q′, which corresponds to the pressure Pc2 on the correlation line L1.

The valve element 3 continues lifting, as the inner pressure increases. Thus, as shown in FIG. 2 by the thick line in a range between the point c and the point d, the relief flow quantity increases along with the correlation line L1. Thereafter, when the inner pressure reaches the pressure Pn1, fluid flows at the specified quantity Qn from the pressure-controlled chamber 2 into the relief chamber 7. Thus, the space between the first seal portion 5 and the first seated position 8 moves into a specified state. Consequently, the valve device 1 is in the specified state.

### Effect of Embodiment

In the valve device 1 according to the embodiment, the first seal portion 5 is seated on the first seated position 8, thereby to form the valve side chamber 10 in which a fluid pressure is equivalent to a fluid pressure in the pressure-controlled chamber 2. Alternatively, when the inner pressure increases to lift the first seal portion 5 from the first seated position 8, the valve side chamber 10 disappears to release the space between the relief chamber 7 and the pressure-controlled chamber 2. In addition, when the valve side chamber 10 is formed, and when the second seal portion 6 is seated on the second seated position 12 in the valve side chamber 10, the region 13 on the radially inner side is partitioned from the region 14 on the radially outer side in the valve side chamber 10. In addition, when the inner pressure increases, the second seal portion 6 is lifted from the second seated position 12, before the first seal portion 5 is lifted from the first seated position 8.

In the present configuration, when the inner pressure increases to the pressure Pc2 thereby to lift the second seal portion 6 from the second seated position 12, the pressure-applied area, via which the internal pressure is applied onto the valve element 3, abruptly increases from the area A2 to the area A1. Therefore, the open-side biasing force also abruptly increases. In the present configuration, after the second seal portion 6 is lifted, the relief flow quantity increases to the quantity ΔQ, without significant increase in the inner pressure from the pressure Pc2. Thus, the valve device 1 is enabled to move into the critical state immediately. Consequently, the present configuration enables to increase the valve opening pressure from the pressure Pc1 to the pressure Pc2, compared with the configuration, in which only the first seal portion 5 block the relief chamber 7 from the pressure-controlled chamber 2.

In addition, after moving into the critical state, the valve element 3 is continually applied with the inner pressure via the pressure-applied area, which is the area A1. Therefore, the relief flow quantity increases along with the correlation line L1. Therefore, after moving into the critical state, the valve element 3 is continually applied with the large open-side biasing force and is biased to increase the relief flow quantity to the quantity Qn. Thus, the valve device 1 is enabled to be in the specified state. Consequently, the present configuration enables to decrease the relief pressure from the pressure Pn2 to the pressure Pn1, compared with the configuration, in which only the second seal portion 6 blocks the relief chamber 7 from the pressure-controlled chamber 2.

In a configuration, in which only the first seal portion 5 is used to block the relief chamber 7 from the pressure-controlled chamber 2, an allowance of the valve opening pressure is a pressure (Pn1−Pc1). In a configuration, in which only the second seal portion 6 is used to block the relief chamber 7 from the pressure-controlled chamber 2, an allowance of the valve opening pressure is a pressure (Pn2−Pc2). To the contrary, according to the present configuration, in which both the first seal portion 5 and the second seal portion 6 are used to block the relief chamber 7 from the pressure-controlled chamber 2, an allowance of the valve opening pressure can be decreased to a pressure (Pn1−Pc2), compared with the pressure (Pn1−Pc1) and the pressure (Pn2−Pc2) in the other configurations.

### Modification

The embodiment of the valve device 1 is not limited to the embodiment and may employ various modifications. For example, according to the valve device 1 of the embodiment, when the valve side chamber 10 is formed, the outflow hole 9 opens in the region 13 on the radially inner side, and the pressure-applied area, to which the inner pressure is applied, is the area A2. The valve device 1 is not limited to the above-described embodiment. For example, when the valve side chamber 10 is formed, the outflow hole 9 may be formed to open in the region 14 on the radially outer side, and the pressure-applied area, to which the inner pressure is applied, may be set to an area A1-A2.

According to the present disclosure, the valve device is configured to release fluid from the pressure-controlled chamber, which is the pressure-controlled object, to reduce a fluid pressure (inner pressure) in the pressure-controlled chamber and to control the inner pressure. The valve device includes the valve element, the biasing unit, the first seal portion, and the second seal portion, as described below.

The valve element is configured to partition and block the relief chamber, which is configured to receive fluid from the pressure-controlled chamber, from the pressure-controlled chamber. The valve element is configured to be displaced, when biased by the inner pressure, to communicate the relief chamber with the pressure-controlled chamber. The biasing unit is configured to bias the valve element in the direction to block the relief chamber from the pressure-controlled chamber.

The first seal portion is a part of the valve element and is configured to be seated on the first predetermined seated position to form the valve side chamber, which is blocked from the relief chamber, to have a fluid pressure (inner pressure) equivalent to a fluid pressure in the pressure-controlled chamber. The first seal portion is further configured to be lifted from the first seated position, on increase in the inner pressure, to cause the valve side chamber to disappear and to communicate the relief chamber with the pressure-controlled chamber. The second seal portion is a part of the valve element. The second seal portion is configured to be seated on the second predetermined seated position in the valve side chamber, when the valve side chamber is formed, to partition a part of the valve side chamber from the other part of the valve side chamber. The second seal portion is further configured to be lifted from the second seated position, on increase in the inner pressure, before the first seal portion is lifted from the first seated position.

In the present configuration, when the second seal portion is lifted in the valve side chamber, the pressure-applied area, via which the inner pressure is applied to the valve element, quickly increases. Therefore, the biasing force (open-side biasing force), which is applied to the valve element toward the open side, also quickly increases. In the present configuration, the valve device moves into the critical state, immediately after the second seal portion is lifted, without significant increase in the inner pressure. Consequently, the present configuration is enabled to increase the valve opening pressure, compared with a configuration, which is equipped with only the first seal portion and configured to block the relief chamber from the pressure-controlled chamber with only the first seal portion, without the second seal portion.

In addition, the valve element is configured to receive the inner pressure via a large pressure-applied area, even after moving into the critical state. Therefore, the valve element is biased by the large open-side biasing force to be in the specified state, after moving into the critical state. Consequently, the present configuration is enabled to decrease the relief pressure, compared with a configuration, which is equipped with only the second seal portion and configured to block the relief chamber from the pressure-controlled chamber with only the second seal portion, without the first seal portion. The above-described configuration enables to reduce the valve opening pressure allowance of the valve device.

It is noted that, in the valve device of Patent Document 1, the valve element (61) may be lifted from the first seated unit (20f) thereby to increase the pressure-applied area, via which the inner pressure is applied to the valve element (61). That is, it can be seen in the valve element (61) of Patent Document 1 that the pressure-applied area is increased from the range on the radially inner side of the first seated unit (20f) to the range including both the radially inner side and the radially outer side of the first seated unit (20f).

Nevertheless, it is further noted that, the valve element of Patent Document 1 does not form a space, which corresponds to the valve side chamber of the present disclosure. In the configuration of Patent Document 1, even when the state between the valve element (61) and the first seated unit (20f) becomes the critical state to release fluid from the pressure-controlled chamber, the released fluid cannot be confined. Therefore, the released fluid cannot bias the valve element (61) effectively toward the open side. Further, in the configuration of Patent Document 1, the state between the valve element (61) and the first seated unit (20f) may finally become the specified state to increase the relief flow quantity sufficiently, and consequently, the released fluid may effectively bias the valve element (61) toward the open side. Therefore, in a transition period from the critical state to the specified state, the region on the radially outer side of the first seated unit (20f) may not function as a pressure-applied surface to receive the inner pressure, substantially.

Therefore, in the valve device of Patent Document 1, the pressure-applied area cannot be increased substantially during the inner pressure increases in transition through the critical state to the specified state. Therefore, in the configuration of Patent Document 1, the valve opening pressure allowance cannot be reduced.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A valve device configured to release fluid from a pressure-controlled chamber, which is a pressure-controlled object, to decrease and control a fluid pressure in the pressure-controlled chamber, the valve device comprising:
a valve element configured
to block a relief chamber, which is configured to receive fluid from the pressure-controlled chamber, from the pressure-controlled chamber and
to be biased and displaced, on application of a fluid pressure in the pressure-controlled chamber, to communicate the relief chamber with the pressure-controlled chamber;
a biasing unit configured to bias the valve element in a direction to block the relief chamber from the pressure-controlled chamber;
a first seal portion being a part of the valve element, the first seal portion configured
to be seated on a predetermined first seated position to form a valve side chamber, which is blocked from the relief chamber to have a fluid pressure equivalent to a fluid pressure in the pressure-controlled chamber, and
to be lifted from the first seated position, on increase in a fluid pressure in the pressure-controlled chamber, to cause the valve side chamber to disappear and to communicate the relief chamber with the pressure-controlled chamber; and
a second seal portion being a part of the valve element, the second seal portion configured
to be seated on a predetermined second seated position in the valve side chamber, when the valve side chamber is formed, to partition a part of the valve side chamber from an other part of the valve side chamber, and
to be lifted from the second seated position, on increase in a fluid pressure in the pressure-controlled chamber, before the first seal portion is lifted from the first seated position.
